(19) United States
(12) Patent Application Publication
(10) Pub. No.: US 2014/0232320 A1
(43) Pub. Date: Aug. 21, 2014

(54) UNIT

(71) Applicants: Maurice Ento July, Lancaster, CA (US); Cedric Ento, Lancaster, CA (US)

(72) Inventors: Maurice Ento July, Lancaster, CA (US); Cedric Ento, Lancaster, CA (US)

(21) Appl. No.: 14/182,814

(22) Filed: Feb. 18, 2014

Related U.S. Application Data
(60) Provisional application No. 61/930,443, filed on Jan. 22, 2014.

(30) Foreign Application Priority Data
Feb. 18, 2013 (GB) 1302749.5

(51) Int. Cl. H02J 7/00; H02J 7/02; B60L 11/18; H02J 7/35

(52) U.S. Cl. CPC H02J 7/0027; H02J 7/0021; H02J 7/355; H02J 7/025; B60L 11/1838; B60L 11/1848
USPC 320/101; 320/110; 320/108; 320/109

(57) ABSTRACT

Increasing numbers of users across the world are increasingly wedded to their electronic devices, particularly portable electronic devices such as laptops, netbooks, portable gaming machines, smartphones or more generally cellphones. Accordingly the present invention provides a unit for charging mobile devices, comprising at least one lockable compartment, at least two charge points for connection of a device to the unit in order to allow charging, a canopy, and power supply.

### FIELD OF THE INVENTION

The present invention relates to a unit for charging mobile devices, more particularly but not exclusively a unit for modular use where required to provide electrical charge to devices in public spaces.

### BACKGROUND

Increasing numbers of users across the world are increasingly wedded to their electronic devices, particularly portable electronic devices such as laptops, netbooks, portable gaming machines, smartphones or more generally cellphones. Despite this prevalence and ubiquity problems remain with charging of such devices, for example wherein requirements of reduced sizing and lighter weight desirable in relation to more mobile devices institutes inherent limits on battery capacity. However charge of said batteries is rarely possible when a user is on the move, or in public spaces, and even where it is, is liable to require a substantial or inconvenient length of time, where users are required to experience downtime from their device and associated features and connectivity during charging.

### SUMMARY OF THE INVENTION

According to the present invention there is provided a unit for charging mobile devices, comprising at least one lockable compartment, at least two charge points for connection of a device to the unit in order to allow charging, a canopy, and power supply.

In preferred embodiments the power supply comprises photovoltaic panels, wherein said panels are dispersed about uppermost surfaces of the canopy. Ideally the canopy comprises a plurality of inclined faces, wherein said faces combine or cooperate to provide a surface that allows capture of solar energy from a plurality of orientations of the sun, during times of the day.

Typically the canopy provides at least three sloped faces that are inclined at an appropriate angle for maximal acceptance or collection of solar rays, dependent on unit elevation or situation.

Accordingly in some embodiments arrangement of the surface or inclination of the faces may be amended at manufacture, retail or after installation.

In some further embodiments the faces may include means to alter orientations. For example there may be included automatic sunlight tracking means, through either mechanical or electronic mechanism. In yet further embodiments the canopy may include a textured, crenelated or otherwise disposed with a plurality of closely arranged faces which provide multiple orientations or raised and lowered sections.

In some further embodiments the energy supply may comprise other energy harvesting means in addition or the alternative, for example wind harvesting apparatus or locally harvested kinetic energy apparatus, for example in some embodiments a user or passer-by interaction means such as a cycle generator or wind-up generator.

In preferred embodiments the unit also includes at least one battery wherein said battery is used to store energy generated by the at least one renewable energy means, and wherein said battery ideally situate in a bank, and is charged sequentially wherein a second battery is charged second and acts to trickle-charge a first battery after said first battery is fully charged, maintaining battery longevity.

In preferred embodiments therefore the power supply comprises batteries, wherein for example photovoltaic panels may act to charge the batteries for later reliance in low light levels and allow backup power supply. In yet further embodiments the at least one battery is charged during appropriate opportunities, for example during low cost periods, from an independently provided electrical supply.

In still further embodiments any combination of energy supplies may be envisaged, to include mains electrical supply from a national or local grid or network. For example grid electrical backup may support faster charging at higher voltages and currents than are typically available from domestic supplies or renewable sources, such as 500 volt DC high-current charging for example for vehicle charging.

In preferred embodiments there is provided at least one interface for customer interaction, said interface being advantageously touchscreen so as minimize damage possibilities in external locations, provide aesthetic appeal and an expandable range of user interactions according to outlay, situation and further requirements wherein said at least one and preferably plural interfaces are dispersed about the unit, preferably on at least one side and in some embodiments arranged at a plurality of heights for different height users. For example children's interfaces may be provided at a lower height. In some further embodiments interfaces may be amendable in height, for example provided on slidable or otherwise rearrangeable mounting. Said interfaces preferably comprise touchscreen means in order that said interfaces are easily maintained and damage from multiple users is minimized, with minimal moving parts that are capable of attracting damage or accumulation of dirt.

Advantageously said interface or interfaces are provided with screen protection, for example wherein displaceable covers may be operable upon operation or protectors and/or robust plastics may be utilized. In preferred embodiments the interfaces may be powered by the power supply.

In some embodiments the at least one compartment comprises an integral wireless charging surface wherein for example the user may insert a wireless charging enabled device without connection of any adaptor or connection. In this way damage to required adaptors may be prevented and general damage and vandalism minimized.

Ideally however the charge points comprise multiple adaptors, to include universal serial bus (USB) min-USB and micro-USB, all of said adaptors preferably allowing two-way communication, and which may be included in the at least one compartment, wherein the compartment(s) may comprise multiple charge points. In some embodiments temporary charge may be situated proximate the interface so as to allow use of a device during its charging.

The charge points may typically or further comprise extendable cables or wires with distal adaptors, for example wherein the wires may be provided on a sprung reel to avoid loss of the adaptors, damage to the wire and accidental displacement or dislocation of the adaptor from the device, ensuring a secure charge point is maintained throughout charging. In addition or the alternative a catch or stay is provided for the device or adaptor.

In some embodiments the catch may comprise a resiliently deformable or sprung clip, wherein the device may be inserted or captured by said stay by displacing a section. In such embodiments preferably the catch includes a resiliently deformable covering so as to minimize damage to the device. In addition or the alternative the compartment or charge point may include magnetic portions.

Further embodiments of the unit may include charge points for electric vehicles wherein said charge points may include cabling appropriate to such utilization, said cabling or cable extendable from the unit upon request and/or authorization.

In preferred embodiments a plurality of compartments is provided wherein the compartments may be arranged proximate each other and accessed by interaction with the interface(s). In some embodiments the compartments may be locked by physical key, wherein said key may be released from the compartment by interaction with the interface and removed by the user, so that the user may then leave their device safely stored and in a charging phase. The key may include wireless connectivity, for example wherein the key may be enabled to alert the user when charging of their device is finished, and/or operate locking wirelessly. For example in some embodiments wireless synchronization may be possible with a third party's device, wherein a text message or other alert is transmitted to said third party device when the user's device is fully charged or to otherwise appraise of status.

Any and all wireless connectivity incorporated in the unit may comprise intermachine operability such as Bluetooth®, shortwave radio, radio frequency identification (RFID), WiFi® or other distance identifiable wireless connection means. Said lockable compartments may be available for use as temporary lockers for other items, wherein payment may be made purely for hiring space in the unit. The unit may in some further embodiments be combined with other uses, for example a ticket booth or information stand.

In preferred embodiments the unit is equipped with a transceiver for wireless networking, for example wherein the unit may provide a wireless connectivity access or connection point for the devices of users, and/or passers-by. Use of said connection may be timed or charged and accessible by use of the interface such as by access or purchase of a keycode.

In preferred embodiments at least some of the compartments are appropriately dimensioned for laptops, tablets or portable computers and standard electrical sockets may be incorporated, for example to charge cameras or camcorders. In some embodiments the interfaces may be connected to a network, wired or wireless, in order to allow interaction with cost structures, for example wherein the user may charge their device with electricity and pay a cost for doing so. Said structure may comprise a debit or credit card structure or system, wherein the user is enabled to pay for electricity, or other use of the unit or associated services, by a charge card or other personalized access means, for example a key, passcode or password, related to an account. In further embodiments in addition or the alternative means may be provided to dispense cash and other banking related functions, by inclusion of an automated teller machine (ATM).

In some embodiments there may be provided keyword or passcode access into the interface, unit and/or system. Said keycode may be programmable and/or may include choices such as user postal code, device or telephone number, user selected password, parent maiden name or any other secret question. In this way the user may be enabled at the unit to insert other forms of payment so as to add credit to the account, for example wherein the unit includes apparatus for acceptance of denominations or synthetic plastic cards or currency. In this way the system may be facilitated for the user wherein the interface may enable full interaction in conjunction with the apparatus so as to manage an account for use of the unit and associated facilities.

According to a further aspect of the invention therefore there is provided an electronic system of maintaining credit on an assigned account, for use with payment for electricity in relation to charge points and/or units substantially described heretofore and available in public locations, wherein said system enables electronic credit addition, subtraction and/or utilizations at these locations by use of other financial structure such as cash currency, bank debit or credit cards.

In preferred embodiments the interface(s) may include gaming, viewing, browsing or shopping equipment, connectivity or software wherein the user may pass time or spend money on the interface, for example whilst waiting for charging of their device. Spending money and/or accessing services is facilitated by the system. Software applications for mobile or other devices may be linked or available for linkage for gaming or payment in relation to or regarding the unit.

In some embodiments plugging a device into a charge point and/or the use interacting at the interface may allow the user to utilize the device's software, data, functionality or capabilities through the interface. In this way the user may be enabled to access data on the device, for example so as to make calls, work on documents, transcribe numbers, play games or send messages from the device, or a proxy server for the device. In this way users may further avoid inconvenience during charging.

Preferred embodiments of the unit further include advertising space or areas, wherein static, moving or interactive advertising may be enabled and/or utilized to pay for upkeep of the unit and/or access to electrical networks where renewable electricity is unavailable, or in short supply.

In some preferred embodiments motion sensors may be utilized on or directed from the canopy or motion or weight sensors elsewhere about the unit, or environs, in order that passers-by may trigger advertisements, the interface(s) or other features of the unit. For example lighting may be provided on the unit for low light levels and in order to maximize efficiency of use of renewable electricity said lighting may be operable solely upon recognition of a presence or user proximate the unit. Ideally a plurality of low voltage light emitting diodes are provided on the canopy or elsewhere on the unit to ensure the unit is well-lit and secure.

In addition or the alternative preferred embodiments of said units may include cameras or video-capture directed to the unit, passers-by or users of the unit, wherein security footage may be recorded and/or interaction achieved, for example registration of an approaching user.

In such fashion preferably the interfaces are equipped with a low power, dormant or sleep mode that operates after non-registration of input after a defined time period. Said time period may be set at manufacture, retail or installation. Some embodiments of the unit may be equipped with seating, for example to aid in enabling disabled access to the interface and/or compartments. Some further embodiments of the unit may be mobile, including lockable wheels or rollers to allow repositioning in a mall or similar.

In preferred embodiments the units may be interconnected and/or modular, whereupon for example a unit may comprise a single compartment, interface and/or canopy and subsequent units may be secured or connected in accordance with local demand.

A central pole may have lights embedded to indicate amount of power that has been collected by the solar cells or how much charge. The unit may have fixed or fold down stool seating and a marble or concrete base.

Further embodiments may include means to make calls using infrastructure or apparatus on the unit, for example fixed headsets, receivers or hand-manipulated apparatus. Said calls may be made using a charging devices Subscriber Identity Module (SIM) card or other elements or features of the device.

Yet further embodiments may allow chargeable voice and/or video calls to other users without a device or SIM. Further embodiments may allow connection of user provided headphones or microphones, so as to for example allow listening to audio through the unit, said audio purchased through, stored on or played through the unit or device; and said microphones enabling alternate interaction with the unit or device.

### BRIEF DESCRIPTION OF FIGURES

FIG. 1 shows an isometric view of a preferred embodiment of the unit;

FIG. 2 shows a reverse isometric view of the embodiment shown in FIG. 1;

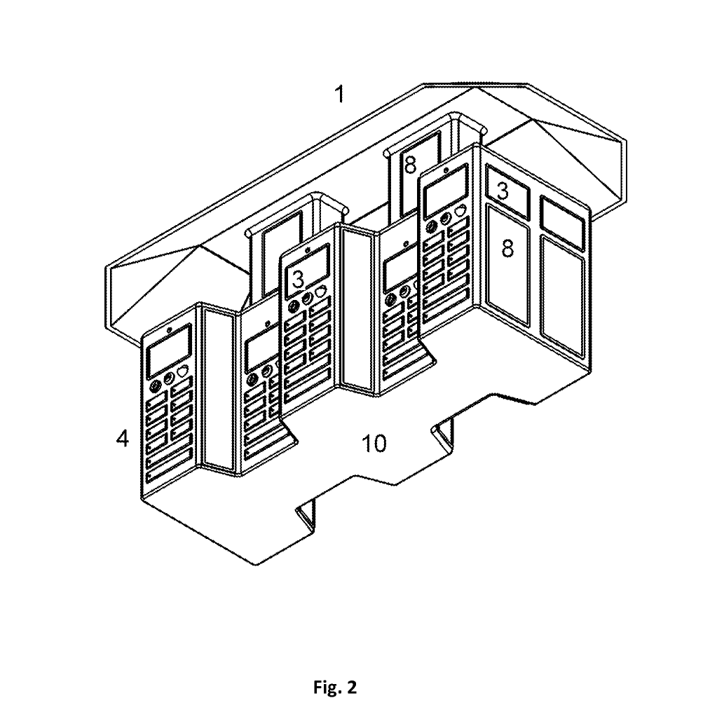

FIG. 3 shows a view from above of the embodiment shown in FIG. 1;

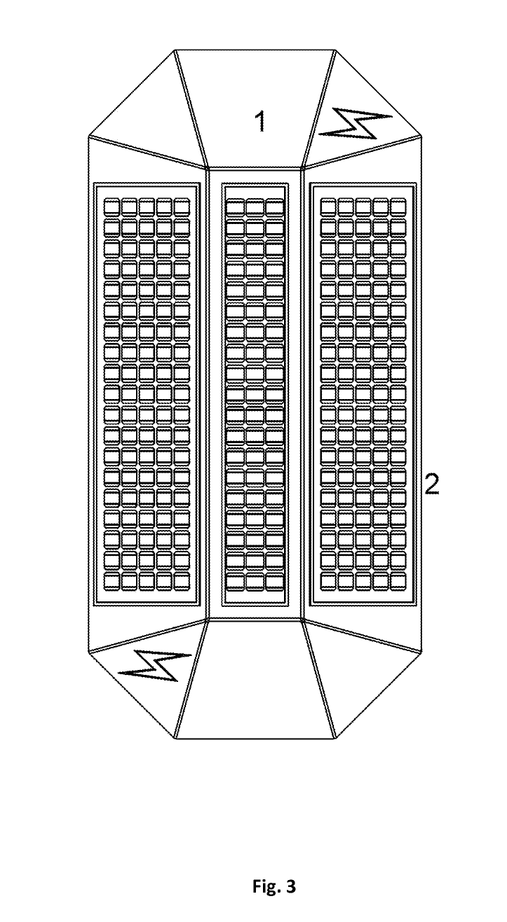

FIG. 4 shows a side view of the embodiment shown in FIG. 1;

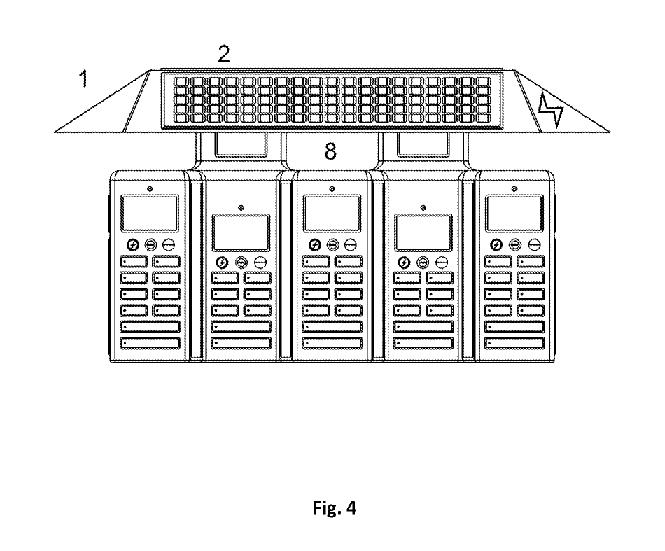

FIG. 5 shows an end view of the embodiment shown in FIG. 1;

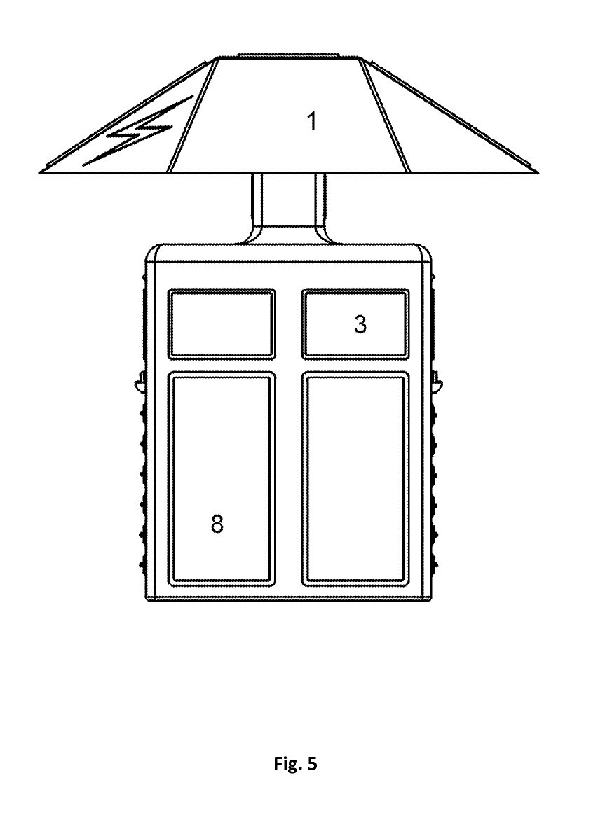

FIG. 6 shows an isometric detail view of a compartment included in an embodiment as shown in FIG. 1;

FIG. 7 shows a simplified isometric view of a unit housing according to an embodiment;

FIG. 8 shows a simplified isometric view of the opposite side of the unit housing of FIG. 7; and

FIG. 9 shows a simplified end view of the unit housing shown in FIG. 7.

### DETAILED DESCRIPTION OF FIGURES

With reference to the figures the unit comprises a canopy 1, over a housing 10, said canopy providing or supporting a plurality of panels 2. Said panels 2 are ideally monocrystalline and/or may additionally be enabled to capture light energy from additional sources such as mall lighting. Said panel(s) 2 may be independently provided to the canopy 1 or integrated at retail or manufacture.

The housing 10 in the pictured embodiment is fixed in shape, wherein the compartments 4, interface 3 and interaction means 5, 6, 7, 9 are fixed in arrangement, wherein fixed, three-dimensional or electronic advertising boards 8 are provided for maximal visibility and wherein an inverter to convert the DC energy to AC, storage battery, wireless connectivity router and electronic equipment are located within the housing core, so as to minimize possibilities of damage. In some embodiments there may be provided lockable doors or shutters, extending for example from the boards or canopy in use, so as to safeguard the unit at night.

In preferred embodiments the interaction means comprise an activation and/or general interaction button 5; and card and banknote slot 6; and coin bin 7. A further interaction means 9 comprises a security camera, microphone, and/or loudspeaker. The compartments 5 vary in size according to envisaged devices. Said difference in size ideally calls for a size related pricing structure, accessible through the interface 3.

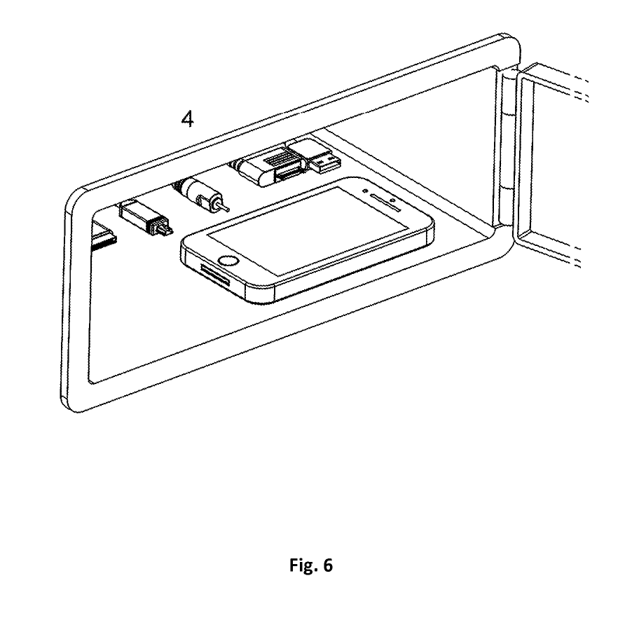

The compartments 5 are solenoid and key operated, and contain a plurality of adaptors and cables as pictured in FIG. 6. The interface 3 allows the user to pick and choose which cable or adaptor they need to charge their electronic device. In order to make simple payment from a charged card the user swipes their card or other passkey item over the button 5 to instantly access the cable needed. Once chosen and paid for, the cable would begin to reel out from the hole and the charge time remaining will appear on the interface 3 and when it has ran out, the charging cable will be reeled back in.

The interface 3 also allows the user to play games and experience other entertainment whilst waiting said games may include team games to encourage spending from third parties whilst the user waits for their device to charge. In such embodiments an easy access interface without a touchscreen or games facility may also be included for dedicated compartment access.

The compartments 5 are unlocked by paying for usage wherein a compartment number will be displayed on the interface 3, which will be unlocked. The compartment 5 is then locked with the device charging inside and the user can then leave the unit and come back when charging time is up. To access their device when their charging time is up they will have to enter their key into the unit so as to open the compartment.

Unit Design

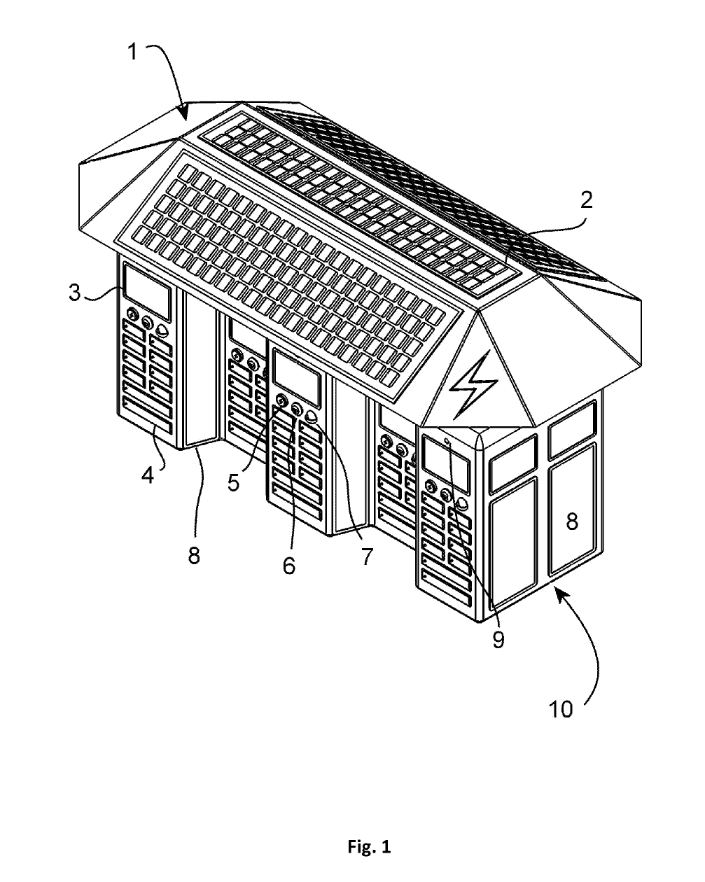

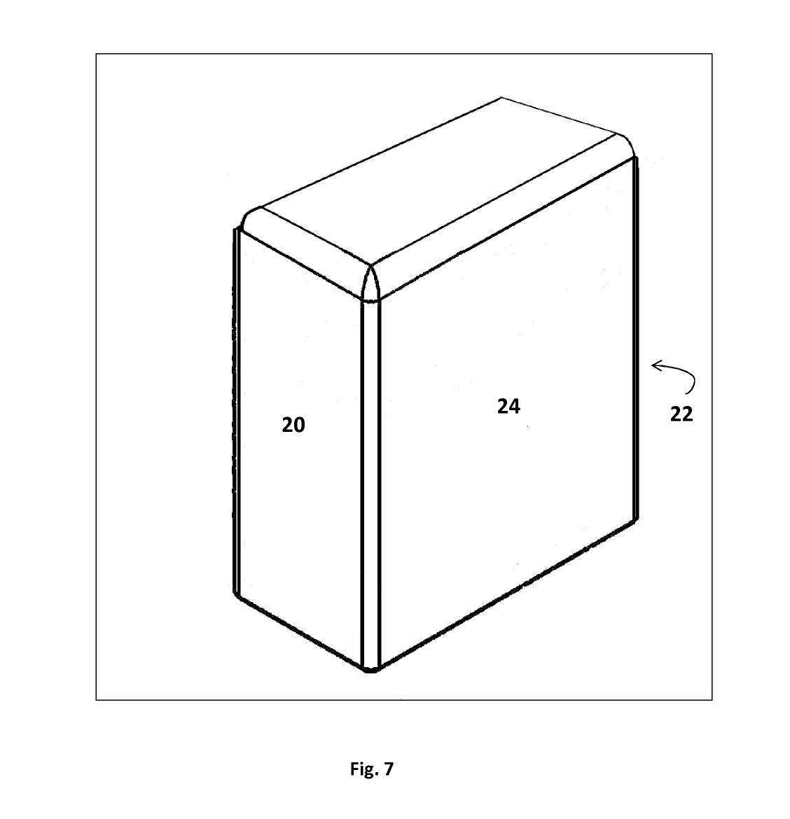

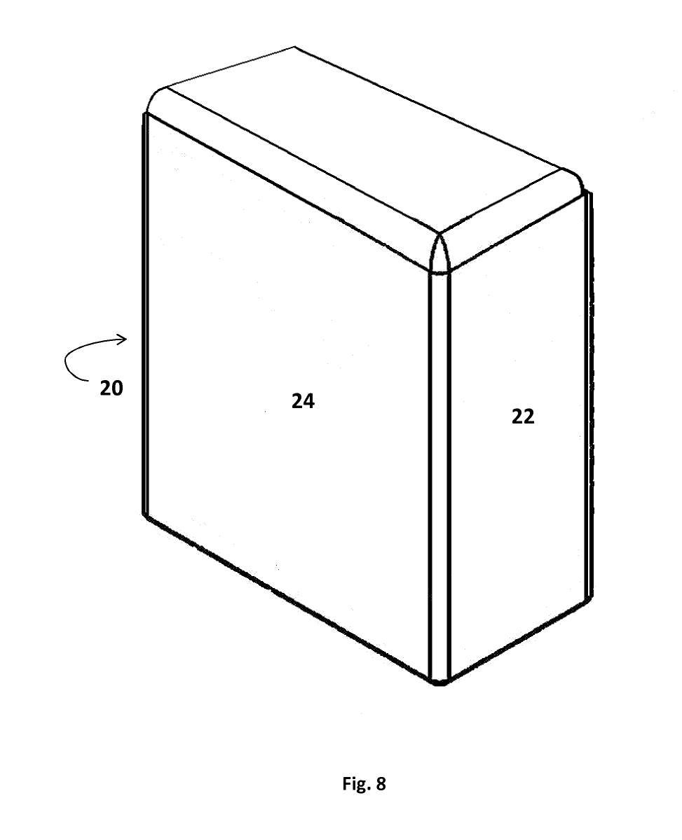

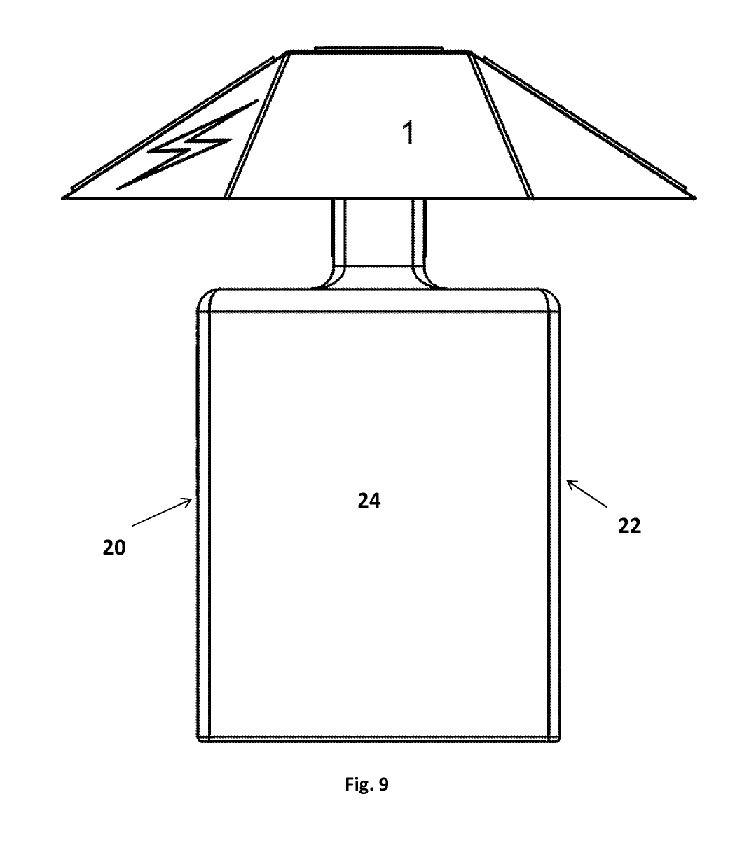

The unit housing may comprise a plurality of repeating structures. Alternatively, the housing may be reduced to just one of the aforementioned repeat structures. For example, as shown in FIG. 7, in one embodiment, the basic design of the unit housing comprises a first surface 20, a second surface 22 and a third surface 24. As shown, the first 20 and second 22 surfaces are different, substantially parallel with respect to each other and both are substantially perpendicular to the floor. The third surface 24 is located between, and substantially perpendicular to, both said first and second surfaces. FIGS. 7, 8 and 9 are depicted without any features (e.g. compartments, displays, etc.) to generally convey the structure of the unit according to one embodiment. Preferably, each of the first 20 and second 22 surfaces comprises access to at least one lockable compartment, at least two charge points, at least one display, at least one interaction means and at least one power supply. Preferably, the interior of each lockable compartment 4 comprises one or more charge points, for example as shown in FIG. 6. In a specific embodiment, both the first 20 and second 22 surfaces comprise access to one or more of the following: compartment(s) 4, interface(s) 3 interaction button(s) 5, bank note slot(s) 6, coin bin(s) 7 and interaction means 9 comprising a security camera, microphone and/or loud speaker. Moreover, the third surface 24 may comprise access to advertising board(s) 8 and/or interface(s) 3. These features may be arranged on the each surface in a variety of ways. In a non-limiting example, the features may be arranged on the appropriate surface in a similar manner as that shown in FIG. 1.

In some embodiments, the unit comprises a canopy 1 comprising photovoltaic panels 2 in operative connection with at least one power supply. The power supply may comprise a battery or any other charge storage device. In some embodiments, the third surface 24 comprises at least one display 3 for gaming, entertainment, news, advertisement, or other information services. The display may be interactive. The third surface 24 may comprise a dedicated advertisement board 8.

In one embodiment, two users simultaneously interact with the unit. For instance one user may access the unit's functionality (features) via the first surface, while the second user may access do the same via the second. In other words, the unit is fully accessible on at least two sides. In a further embodiment, a third user, simultaneously with the other two users, interacts with (or otherwise derives a benefit) the unit, via the third surface. During use, at least two such units may be located within proximity of each other. Preferably, they are operatively connected. Alternatively, the units are operatively connected to a central unit which provides data, power, computing or other needs. Moreover, various software or computing needs may be provided to one or more units via cloud technology.

Multi-Unit Station

As noted earlier, in one embodiment several units may be connected to form a single station. This arrangement of a plurality of units into one large structure, as described above (e.g. resembling that of FIG. 1), can provide various benefits. For instance, the size of the station may be altered by adding or removing units based on factors such as anticipated need, space availability or requirements for special events. Moreover, the units can serve as back up for other units if one fails or malfunctions. More specifically, one or more units may provide other units with power, computing capacity, data or any other operational need. Finally, in some cases units may be arranged at various positions in the station based on the characteristics of the unit to enhance, efficiency, accessibility and aesthetics. For example, the station may comprise an arrangement of alternating units, each having a different dimension (e.g. similar to that of FIG. 1).

In one embodiment, the station comprises a plurality of units that are operatively connected. For instance the units may be connected to share any operation need, including but not limited to, power, data, storage and/or processing power. Thus, the connectivity may include arrangement of the units in series, parallel or both. Moreover, the units may be physically interconnected in any manner to enhance efficiency, accessibility and aesthetic appeal. In the most preferred embodiment, the units are arranged in series, wherein each unit is accessible on at least two sides. That is, users on both sides of a single unit in the station have independent access to storage, charging, display(s) for internet, ecommerce, entertainment, gaming and other services.

This two-sided design also enhances efficiency and allows many users to access the station at any given time. In one embodiment, the station comprises at least two units, more preferably at least five. In a specific embodiment, the station comprises a plurality of units and can serve at least 100 users at one time.

The units in the station may be independent from or partially dependent on other units. For instance a unit may be independent in the sense that it comprises its own power source, display(s), storage/charging compartments and computing/hardware components for carrying out the aforementioned functions. In some embodiments, at least one unit depends on other unit(s) for power, media content or computing/hardware needs.

In one embodiment, each unit comprises a canopy comprising photovoltaic cells such that each unit has its own power source. In a further embodiment, the power generated by each unit is stored on separate (or connected) batteries, or one battery serving the entire station. In an alternative embodiment, the power generated from each unit is collectively managed by a dedicated unit, or a power management system that is separate from each unit. Where each unit comprises a canopy, said canopies may be physically connected.

In some embodiments, the station may comprise at least one dedicated unit. In such embodiments, the units may be dedicated to various functions while independent from or dependent on other units. For instance, in a non-limiting example, at least one unit may comprise a canopy (comprising photovoltaic cells) large enough to provide power (directly or indirectly) to at least one other unit (in the station) that does not have its own power source. In this sense, the unit may be a power-dedicated unit and relying on any of the previously mentioned resources (e.g. solar, wind, kinetic, etc.) to generate power.

In another embodiment, a unit may be dedicated to serving handicap children or other special needs users. As a non-limiting example, such units may be equipped with accommodations such as braille, voice-interactive displays, lower positioned display and controls, as well as railing.

In yet another embodiment, a unit may be dedicated to providing resting and/or working accommodations for all users. For instance, the unit may provide at least one seating and/or at least one table suitable for rest/work/leisure activities. The table and seating may be provided via pull-out, fold out, or any other mechanism known in the art. In a particular embodiment, the table or seating comprises a power source for various devices. Such special functionality may be unlocked via payment.

In one embodiment, a unit may be dedicated to providing certain software needs such as updates, backup, virus/malware scanning or other diagnostic services. Further, the unit may allow the stored device access to a library of digital media for download. The software services may be paid or free.

In one embodiment, a unit is dedicated to providing photo services. For example, the unit may also comprise a booth or curtains for privacy. Moreover, the system provides options for customizing the photo by adding visual effects, costumes or an avatar.

Certain dedicated units may be preferably located at the terminal portion of the station to maximize benefit. As a non-limiting example, gaming and advertisement may require a large display screen that is more practically positioned on a large surface at either end. As yet another example, the seating/table or special needs provisions may be more suitably provided at the end portions of the station as well.

It should be noted that while some units specialize or are dedicated to providing a particular function, such units preferably also provide the main functions mentioned in this disclosure, including but not limited to, device storage, charging and maintenance, as well as internet, e-commerce, ticketing, entertainment, gaming and news delivery.

In one embodiment at least one unit is configured to display emergency messages. Such messages may source from various government agencies. The message can include any warning issued with the Emergency Alert System. In particular, content of the message may include warnings regarding weather, ongoing/threatened criminal activity, terrorism-related activity, AMBER alerts and the like.

In a special embodiment, the at least two units in the station are manufactured (or authorized for manufacture) by different companies. Such scenario allows various companies to obtain licenses to design and add units to the station while the station retains operative connection and compatibility between all units. Still, these companies may be afforded significant leeway for designing the aesthetic and functional aspects of the unit. This may be beneficial to companies that wish to further promote their brand and sell device-specific goods/services such as software, diagnostics, maintenance and periphery.

The invention has been described by way of examples only and it will be appreciated that variation may be made to the above-mentioned embodiments without departing from the scope of invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A unit comprising,
a first surface;
a second surface;
a third surface;
at least two lockable compartments;
at least two charge points;
at least two displays;
at least two interaction means;
at least one power supply; and
at least one canopy;
wherein said first and second surfaces are substantially parallel with respect to each other, and said third surface is located between and substantially perpendicular to, both said first surface and second surface, and
wherein said first surface and second surface, each comprise access to at least one lockable compartment, at least one charge point, at least one interaction means and at least one display.

2. The unit of claim 1, wherein said third surface comprises at least one display.

3. The unit of claim 1, wherein at least two charge points are located within each said compartment.

4. The unit of claim 1, wherein at least one canopy comprises photovoltaic panels in operative connection with at least one power supply.

5. The unit of claim 1, wherein the interaction means comprises a camera.

6. A station comprising a plurality of physically connected units according to claim 1.

7. The station of claim 6, wherein the units are operatively connected.

8. A unit for charging mobile devices, comprising
at least one lockable compartment;
at least two charge points for connection of a device to the unit;
a canopy; and
a power supply.

9. The unit of claim 8, comprising photovoltaic panels.

10. The unit of claim 8, wherein at least one lockable compartment comprises dimensions suitable for storing portable personal computers.

11. The unit of claim 8, comprising touchscreen interfaces.

12. The unit of claim 8, further comprising wireless connectivity.

13. The unit of claim 8, wherein the unit comprises connectivity to wireless networks.

14. The unit of claim 8, wherein at least one charge points enables transfer of data from a connected device.

15. The unit of claim 8, wherein the interface allows interaction with data on a connected device.

16. The unit of claim 8, further comprising an interface which comprises an audio element.

17. The unit of claim 8, wherein the unit comprises at least one camera.

18. The unit of claim 8, wherein the unit comprises at least one motion sensor.

19. The unit of claim 8, further comprising a charge point to allow connection of a vehicle.

20. The unit of claim 8, wherein said unit is modular.
